(19) United States
(12) Patent Application Publication
(10) Pub. No.: US 2006/0105775 A1
(43) Pub. Date: May 18, 2006

(54) Method, system, and program for network design, analysis, and optimization

(76) Inventors: Tim A. Von Kaenel, Coto De Caza, CA (US); Jonathan D Goodwin, Laguna Niguel, CA (US); Steven M Schattmaier, Dana Point, CA (US)

Correspondence Address: MEADWESTVACO CORPORATION, REGIONAL OFFICE BUILDING, PO BOX 118005, CHARLESTON, SC, 29423-8005, US

(21) Appl. No.: 10/537,715

(22) PCT Filed: Dec. 16, 2003
(86) PCT No.: PCT/US03/39945

§ 371 Date: Jun. 3, 2005

Related U.S. Application Data
(63) Continuation-in-part of application No. 10/388,666, filed on Mar. 14, 2003.
(60) Provisional application No. 60/433,597, filed on Dec. 16, 2002.
(60) Provisional application No. 60/437,990, filed on Jan. 6, 2003.
(60) Provisional application No. 60/449,601, filed on Feb. 26, 2003.
(60) Provisional application No. 60/364,807, filed on Mar. 16, 2002.
(60) Provisional application No. 60/433,597, filed on Dec. 16, 2002.
(60) Provisional application No. 60/437,990, filed on Jan. 6, 2003.

(51) Int. Cl. H04Q 7/20

(52) U.S. Cl. 455/456.1; 707/102; 707/104.1; 701/208; 340/995.12; 340/995.14; 340/995.18; 455/404.2

(57) ABSTRACT

Provided are a method, system, and program for rendering information on network infrastructure. A selection of customer sites is received and a database is queried to determine geographical locations of the selected network sites. A graphical user interface is rendered including representations of the selected customer sites in a map at the geographical location of the selected sites in the map. Selection is received of at least one network service provider (NSP). The database is queried to determine network infrastructure of the selected NSP and geographical locations of the determined network infrastructure. Representations are rendered of the determined network infrastructure in a map at the determined geographical locations of the determined network infrastructure to render a visualization of the geographical locations of the selected customer sites and network infrastructure of the selected at least one NSP in the map.

### RELATED APPLICATIONS

This application is a non-provisional application claiming priority from the following applications:

U.S. Provisional Application No. 60/384,807, entitled “A SYSTEM AND METHOD AND COMPUTER PRODUCT FOR COUPLING A DATA PROCESSING CENTER TO A LIVE DATA PROCESSING CENTER TO PROVIDE FOR SPATIALLY VIEWING, ANALYZING, AND SHARING ENTERPRISE DATA AND GEOSPATIAL DATA ACROSS MULTIPLE USERS,” by T. von Kaenel et al., filed on Mar. 16, 2002, and which is incorporated by reference herein in its entirety;

U.S. Provisional Application No. 60/433,597, entitled “SYSTEMS AND METHODS FOR REAL-TIME EVALUATING AND REPORTING ASSOCIATED WITH INSURANCE POLICY UNDERWRITING AND RISK MANAGEMENT,” by S. Kumar et al., filed on Dec. 16, 2002, and which is incorporated by reference herein in its entirety;

U.S. Provisional Application No. 60/437,990, entitled “SYSTEMS AND METHODS FOR REAL-TIME EVALUATING AND REPORTING ASSOCIATED WITH INSURANCE POLICY UNDERWRITING AND RISK MANAGEMENT,” by S. Kumar et al., filed on Jan. 6, 2003, and which is incorporated by reference herein in its entirety;

U.S. Provisional Application No. 60/449,601, entitled “SYSTEMS AND METHODS FOR NETWORK DESIGN, ANALYSIS, AND OPTIMIZATION,” by Tim A. von Kaenel, filed on Feb. 26, 2003, and which is incorporated by reference herein in its entirety; and

is a Continuation-In-Part of U.S. application Ser. No. 10/388,666, entitled METHOD, SYSTEM, AND PROGRAM FOR AN IMPROVED ENTERPRISE SPATIAL SYSTEM,” by T. von Kaenel et al., filed on Mar. 14, 2003, and which is incorporated by reference herein in its entirety.

### BACKGROUND OF THE INVENTION

1. Field of the Invention

The present invention relates to method, system, and program for network design, analysis, and optimization.

2. Description of the Related Art

Businesses often seek the advice of network designers on ways to design, analyze and/or optimize network infrastructure. Such network infrastructure may make up any type of network, such as a local-area network (LAN), a home-area network (HAN), a campus-area network (CAN), a metropolitan-area network (MAN), and/or a wide area network (WAN), any of which may include of one or more of a data network, a telecommunications network, a fiber optic network, a wireless network, as well as any other type of network. Moreover, such design, analysis, and/or optimization may involve creating a new network or modifying an existing network, such as by adding to and/or replacing a portion of the existing network.

In designing, analyzing, and/or optimizing a network, the network designer may have to identify the data-handling capacity and the cost of operating the business's desired (i.e., existing and/or proposed) network, the business's objectives and requirements for the desired network, and the network infrastructure and services that are available for designing and/or optimizing the desired network. The network designer may then design and price a network proposal that meets the network requirements.

Particularly challenging for the network designer is the task of identifying network service providers (NSPs) that provide network infrastructure and service (e.g., fiber optic service, wireless service, data service, telecommunications service, etc.) in a region of interest for a desired network. In many instances, a network designer may not know which NSPs service a particular region and what network infrastructure a particular NSP may provide in the region.

Currently, a business that wants to design, analyze, and/or optimize a network will identify the desired network for the network designer. This identification of the desired network may include a list of the addresses (e.g., mailing addresses) for the business locations on the desired network. The desired network connections may also be provided to the network designer, such as in the form of a list identifying the network connection types (e.g., a T1 or a T3 connection) between identified pairs of addresses for the business locations on the network. With this data, the network designer may compute the capacity or bandwidth of the desired network, or a portion thereof, in any well-known manner.

Typically, with no more than this data, a network designer will contact the NSPs believed to serve a region encompassing the desired network to identify those NSPs that offer the desired network services. The network designer may contact each such NSP to describe the desired network and to request a proposal. The network designer then obtains the NSP offers, selects the best ones, and reports them to the business for further consideration.

### BRIEF DESCRIPTION OF THE DRAWINGS

Referring now to the drawings in which like reference numbers represent corresponding parts throughout:

FIG. 1 is a block diagram of a system in accordance with the present invention;

FIG. 2 is a flowchart diagram of a method in accordance with the present invention;

FIG. 3 illustrates a computing environment in accordance with embodiments of the invention;

FIGS. 4a, 4b, 4c, 5a, and 5b illustrate information maintained in a network design database in accordance with embodiments of the invention;

FIGS. 6, 8, 11, 13, 17, and 23 illustrate operations performed by the network design tool in accordance with embodiments of the invention; and

FIGS. 7, 9, 10, 12, 14-16, 18-22, and 24-26 illustrate examples of a graphical user interface rendering network information in accordance with embodiments of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

### Identifying a Network Service Provider to Use to Provide Network Services for a Distributed Network

Systems and methods consistent with the present invention assist a network designer in evaluating NSPs according to their ability to cost-effectively provide network services in support of a desired network. To this end, the systems and methods consistent with the present invention may employ an NSP database, which may include data to help a network designer in making such evaluations. For instance, the NSP database may include data representing user-selectable criteria that may be utilized by a network designer to evaluate each NSPs' ability to cost-effectively provide desired network services and to evaluate each NSPs' offer.

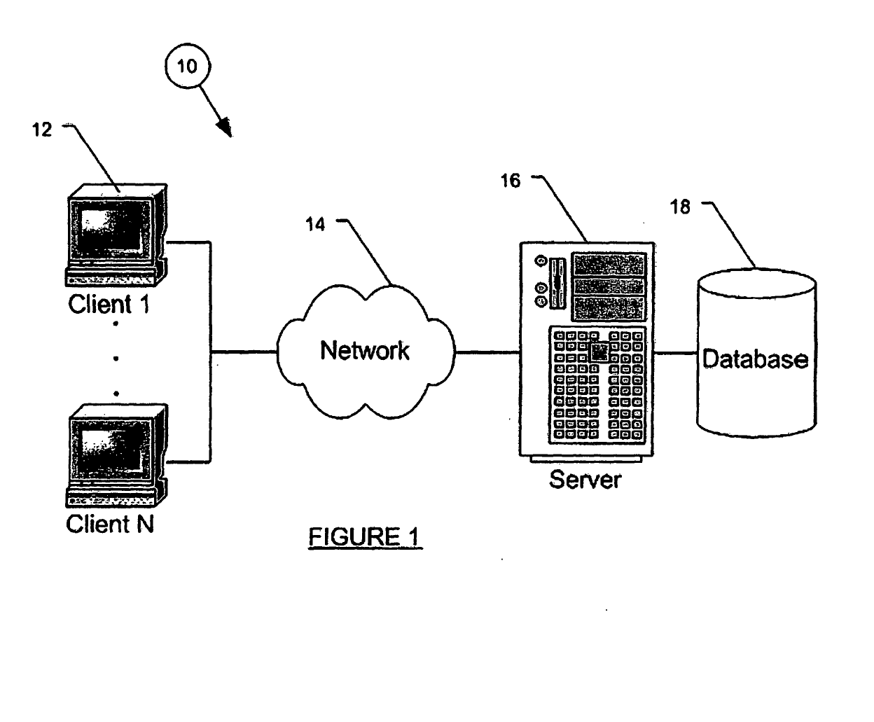

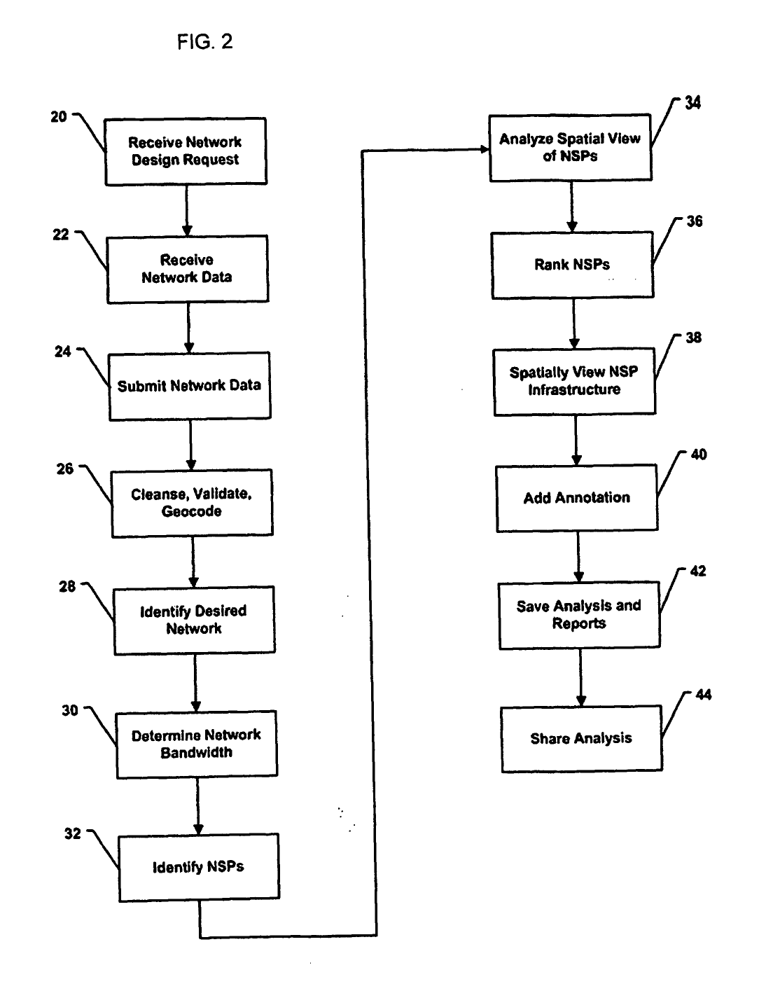

FIG. 1 illustrates an exemplary system 10 consistent with the present invention. System 10 may include one or more client computers 12 for connection through a network 14, such as the internet, to a server 16, which may be connected to a database 18. Client computers 12 may comprise any conventional computer or other client device that may include software, such as a web browser, for accessing server 16. Similarly, server 16 may comprise any conventional server that may execute any conventional software code for implementing the method depicted in FIG. 2.

As further described below, database 18, which may comprise one or more databases, includes data that may be used by a network designer to evaluate NSPs according to their ability to cost-effectively provide desired network infrastructure and to evaluate each NSPs' offer. For example, database 18 may include data for conventionally displaying with a web browser on client computer 12 images, such as maps, which may simultaneously depict one or more of: 1) a business's desired network (e.g., addresses of business locations and their respective network connections for an existing network and/or a proposed network); 2) NSP infrastructure (e.g., fiber optic lines, switches, cell towers, etc.) that may be used to provide the business's desired network; and 3) any other images or information that may be useful to a network designer in evaluating NSPs according to their ability to cost-effectively provide the desired network, such as geospatial data that may depict images of roads, boundaries, rivers, etc., particularly in and around the area for the requested network.

FIG. 2 illustrates an exemplary method consistent with the present invention. In step 20, a network designer may receive a network design request. In one instance, a business may ask the network designer to design a new network. Alternatively, a business may ask the network designer to determine whether some part or the whole of the business's existing network may be optimized, expanded, and/or replaced. For example, a business may ask the network designer to replace (or add to) a portion of the business's existing network with fiber optic infrastructure (e.g., fiber optic lines, switches, etc.) such that the completed network's system performance is improved (or at least not reduced) while operating costs are reduced (or maintained). Any conventional means of reporting the request to the network designer may be used, such as telephone conference, email, facsimile, and the like.

In step 22, the business may provide the network designer with data that may identify the desired network. Such data may include the addresses for business locations in the desired network, as well as network connections, such as a T1 or a T3 line, between identified pairs of business locations. The desired network may include addresses for business locations and network connections for: 1) an existing network that may be optimized; 2) an existing network that may be optimized and integrated with one or more additional proposed networks; or 3) a newly designed network. Any conventional means of reporting the desired network data to the network designer may be used, such as telephone conference, email, facsimile, and the like. Alternatively, the network designer may research to assemble data that identifies the business's existing network infrastructure.

In step 24, the network designer may submit from client computer 12 to server 16 the network data reported at step 22 to identify the desired network (i.e., an existing network and/or a proposed network). For example, the network designer may submit to server 16 the network data in a flat file form or by entering the network data into a web form using client computer 12. Network data for submission to server 16 in a flat file form may be stored in client computer 12 in a CSV format (comma separated values) or any other suitable format. Network data for submission to server 16 by entering the data into a web form may be made available to server 16 using any conventional web hosting technology. In addition to providing the network data (e.g., business address locations and network connections for the desired network) to server 16, the network designer may use client computer 12 to add to, delete, or otherwise change the network data, either before or after having been provided to server 16.

In step 26, server 16 may employ one or more conventional programs to perform the well-known geographic information system (GIS) processes of cleansing, validating, and geocoding the data identifying the desired network. To cleanse and geocode the desired network data, the Centrus AddressBroker product from Sagent Technology, Inc. of Mountain View, Calif. may be used. Oracle version 9.1.0.4 with Spatial Extensions may be used to validate the desired network data in any manner well known to those skilled in the art. However, those skilled in the art understand that any other conventional programs may be used to cleanse, validate, and geocode the data identifying the desired network. The GIS preparation (e.g., cleansing, validating, and geocoding) of the desired network data for display on client computer 12 may be automated in any well-known manner such that the business locations for the desired network and their network connections may be viewed in an image, such as a map, on client computer 12. To facilitate such viewing, server 16 may also store in a database, such as database 18, at least the data for such network infrastructure.

Geocoding is a well-known GIS process that, among other things, may permit displaying objects on a map. The geocoding process may associate with each business address provided in step 22 a latitude and a longitude value. Following such associations, a geocoded (as well as cleansed and validated) business address location may be queried using conventional GIS spatial queries to determine the address's location relative to the location of any object that may be represented by other geocoded data sets that may be accessed by server 16. For example, using conventional GIS spatial queries, server 16 may determine the relative spatial positioning between two or more objects (e.g., between an address location and a point on an NSP's fiber optic line that may be considered for network service to the address location). Having determined the correct relative spatial positions between a plurality of objects that may be represented with geocoded data, server 16 may correctly show the objects in an image, such as a map, on a client computer display.

At step 28, the network designer may identify for his further consideration a network that is the same as, smaller, or larger than the one specified by data received in step 24 (i.e., the business address locations and network connections from step 24). For example, the network designer may identify a set of building locations, which may include all of the building locations submitted at step 24, less than all of these locations (if, for example, only a portion of the network was to be optimized), or more than all of these locations. In addition to identifying the building locations for network designer consideration, the network connections may be identified by server 16 automatically selecting all of the network connections identified in step 24 that connect to any of the business locations selected in step 28. The set of building locations and network connections identified in step 28 may ultimately be contained in a network proposal by the designer such that they are connected in a manner to enhance network efficiency, such as by replacing some or all of the prior network connections with lines having improved data-handling capacity (e.g., fiber optic).

The network data from step 24 (e.g., business locations and network connections) may be viewed by the network designer on a client computer display to facilitate the identification of step 28. Geocoding of the network data may facilitate such viewing. Any conventional technique may be employed for this identification. For example, using client computer 12 the network designer may send server 16 conventional GIS spatial queries that would retrieve from database 18 the desired business locations and network connections. Alternatively, the network designer may select from a menu of predefined identification options (e.g., select all of the business locations and network connections from step 24). Also, the network designer may use a graphical use interface (GUI), such as a mouse-driven pointer, to conventionally select one or more regions on the client computer display, the selected regions displaying the business locations and network connections that are to be the network identified in step 28 for network designer consideration.

At step 30, server 16 may compute the total bandwidth requirements for the desired network identified in step 28. Those skilled in the art understand that this computation may be done in any one of several conventional ways that may utilize, as a factor, the bandwidth of the desired network, as identified at step 28, across the building locations and network connections identified in step 28.

At step 32, the network designer may select one or more criteria to identify NSPs that may be able to provide the infrastructure needed to configure the desired network identified in step 28, pursuant to the requirements of the selected criteria. The network designer may use a GUI, such as a mouse-driven pointer, to select from a set of predefined criteria shown on the client computer display. Client computer 12 may send the selected criteria to server 16, which may then access the NSP database to retrieve the NSPs that may fulfill the requirements of the selected criteria. In retrieving the sought-after NSP data, server 16 may send conventional GIS spatial queries to the NSP database.

One such criteria may be used to identify NSPs that may provide fiber optic service, such as one or more fiber optic lines and fiber optic switches, to one or more building locations in the desired network of step 28. Alternatively, a selection criteria may be used to identify NSPs that provide a predefined network service, such as fiber optic service, within a defined distance from one or more building locations in the desired network of step 28. For example, although a particular NSP may not provide fiber optic service to any building location identified in step 28, the NSP may provide fiber optic service within a defined distance of one or more of the identified building locations (i.e., the NSP may have a fiber optic line less then a defined distance from a building location).

Those skilled in the art understand that there may be a number of other criteria that could be valuable to the network designer in endeavoring to evaluate NSPs according to their ability to cost-effectively design, analyze, and/or optimize a business's desired network and to evaluate each NSPs' offer. For example, the network designer may find it useful to know: 1) how long specified NSPs have been offering a specified service; 2) the size of the customer base in a specified service for specified NSPs; 3) the total bandwidth offered by a specified NSP for a specified service; 4) the available bandwidth offered by a specified NSP for a specified service; and 5) any other criteria that a network designer may find useful to identify NSPs for making such evaluations.

Accordingly, the NSP database, which may be a part of or separate from database 18, may include any of such criteria, which may be stored as conventionally cleansed, validated, and geocoded data. Any commercially available database with such data may be used for the NSP database. For example, GeoTel, Inc. of Orlando, Fla. provides GeoTel Data Sets called GeoTel Fiber, GeoTel Connect, GeoTel Exchange, GeoTel Networks, GeoTel Wireless, and GeoTel Analyst that include network infrastructure data for NSPs providing fiber optic, data, voice, and wireless services. Regardless of whether a commercially available database that may be used for the NSP database is available from the manufacturer with cleansed, validated, and geocoded data, those skilled in the art understand that one or more conventional programs may be used to cleanse, validate, and geocode the NSP data. For example, to cleanse and geocode the NSP data, the Centrus AddressBroker product from Sagent Technology, Inc. of Mountain View, Calif. may be used. Oracle version 9.1.0.4 with Spatial Extensions may be used to validate the NSP data in any manner well known to those skilled in the art. However, those skilled in the art understand that any other conventional programs may be used to cleanse, validate, and geocode the NSP data.

At step 34, the network designer may analyze one or more spatial views depicting network infrastructure for the NSPs identified in step 32 that may be used to fulfill the proposed network of step 28. The client computer display may provide a series of user-selectable viewing options for the network designer, such as viewing network infrastructure for one or more of the NSPs identified in step 32. For example, a list of NSPs identified in step 32 may be displayed on client computer 12 from which the network designer may select one or more to view the network infrastructure available to provide the desired network identified at step 28. Those skilled in the art understand that server 16 may use conventional GIS spatial queries to retrieve from the NSP database the requested spatial views of NSP infrastructure, such as a view that depicts the available fiber optic network infrastructure for an NSP that has fiber optic service available to one or more business locations identified at step 28. It will also be apparent to those skilled in the art that the data in the NSP database representing available NSP network infrastructure may be geocoded for displaying purposes.

At step 36, the network designer may request for the NSPs identified in step 32 a ranking of their ability to provide cost-effective service for the desired network. Client computer 12 may display a list of ranking criteria from which the network designer may select with a GUI, such as a mouse-driven pointer. To perform the requested ranking, server 16 may send conventional GIS spatial queries, as known to those skilled in the art, to database 18 to compare the network infrastructure of the NSPs identified in step 32 with the desired network of step 28.

For example, one ranking criteria may rate the NSPs identified in step 32 by determining for each such NSP the number of business locations identified in step 28 to which the NSP has network service, such as fiber optic service, already connected (i.e., the number of “hits”). For this exemplary ranking criteria, server 16 may display on client computer 12 a list of the NSPs, arranged in order according to their respective number of “hits.” An alternative criteria may be used to rank NSPs that provide a predefined network service, such as fiber optic service, within a defined distance from one or more building locations in the desired network of step 28.

Such rankings may be valuable to the network designer in evaluating the NSPs, because they indicate for each NSP how many business locations in the desired network are already connected to, or within a defined distance of, a sought-after networking service, such as fiber optic service. For example, if the network designer knows that a particular NSP has the most fiber optic service “hits” to or near business locations in the desired network, then the designer may conclude that that NSP should, with all other factors being equal, be able to provide the most cost-effective quotation. The network designer may reach such a conclusion because the NSP that provides the requested network service, such as fiber optic service, to or near to the most business locations does not have to spend as much money (and pass it along in their quotation to the network designer) to establish new fiber optic connections.

At step 38, the network designer may spatially view on the client computer display the network infrastructure available from a specified NSP for servicing the desired network identified in step 28. Client computer 12 may display a list of the NSPs identified in step 32, such as an NSP ranking list from step 36. Using a GUI, such as a mouse-driven pointer, the network designer may select one or more of the listed NSPs. Server 16 may then use conventional GIS spatial queries to database 18 to retrieve for display on client computer 12 the selected network infrastructure, such as a particular NSP's fiber optic network infrastructure for servicing the desired network identified in step 28.

In step 38, the network designer may also select with a GUI, such as a mouse-driven pointer, an option for server 16 to generate and display one or more reports that may contain: 1) a spatial view of the complete set of building locations (from step 24); 2) a spatial view of the desired network (from step 28); 3) the bandwidth requirement for the desired network (from step 30); 4) a spatial view of the building locations with “hits” (whether they be direct “hits” to a building location or “hits” within a defined distance of a building location) for a specified NSP, such as the NSP capable of providing the most cost-effective service quotation (from step 36); and 5) a spatial view of the network infrastructure for the desired network from a specified NSP, such as the NSP capable of providing the most cost-effective service quotation (from step 38).

In step 40, the network designer may annotate any of the reports from step 38. For example, the network designer may use a client computer GUI, such as a mouse-driven pointer and/or a keyboard, to instruct server 16 to incorporate text, such as a title and a subtitle for a report, shapes, such as arrows to specified areas in a spatial view of a report, or any other information that the network designer wishes to incorporate into a report.

In step 42, the network designer may use client computer 12 to direct server 16 to save on database 18 any of the results from the analysis that was performed or any of the reports that were generated for sharing, at step 44, with a customer, other consultants, or any other interested party.

It will be apparent to those skilled in the art that various modifications and variations can be made to the system and method of the present invention without departing from the spirit or scope of the invention. For example, although aspects of the present invention may be described as replacing existing network infrastructure with a fiber optic network, one skilled in the art will appreciate that systems and methods consistent with the present invention may also be employed to create, optimize, expand, and/or replace desired network infrastructure using non-fiber optic networks, such as wireless networks, traditional data networks, telecommunications networks, etc. The present invention covers the modifications and variations of this invention provided they come within the scope of the appended claims, or any subsequently-filed claims, and their equivalents.

### Network Design Tool

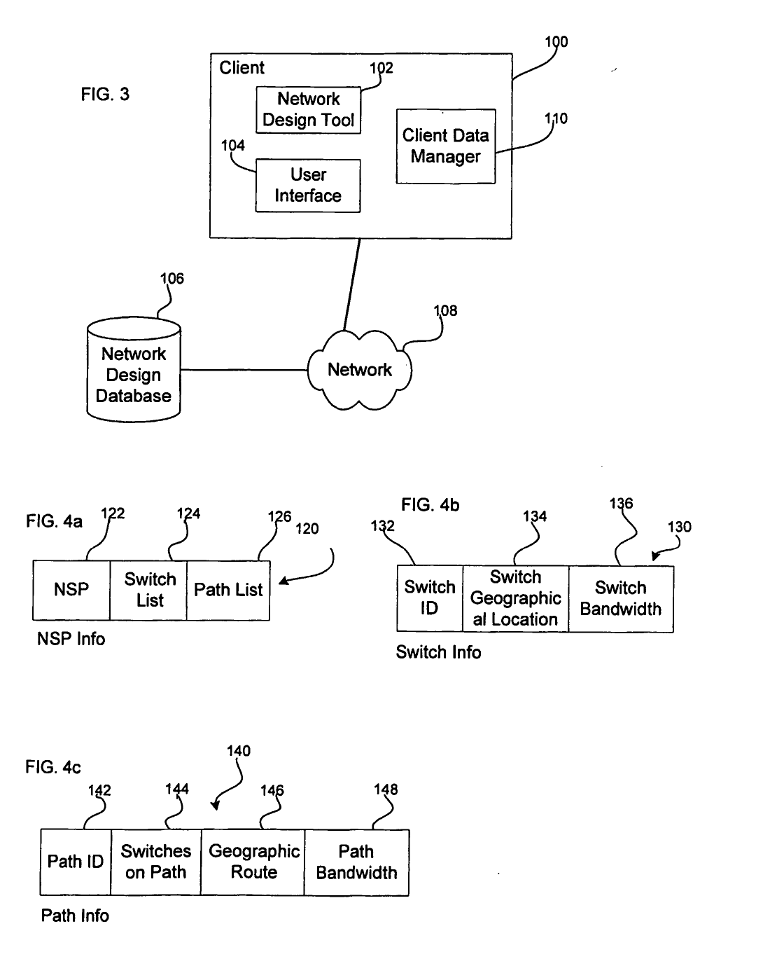

FIG. 3 illustrates a computing environment in which embodiments may be implemented. A client system 100, which may comprise any computing device known in the art, such as a workstation, desktop computer, laptop computer, hand held computer, server, telephony device, etc. The client 100 includes a network design tool 102 to enable an administrator to design their network infrastructure and select NSPs to use to provide the network connections, including entry/exit points in buildings, protocols to use, fiber connections, etc. The network design tool 102 would render a user interface 104, which may comprise a graphical user interface (GUI), to enable a user to interact with a network design database 106 having information on network infrastructure available through recognized NSPs. The network design tool 102 may query the network design database 106 to determine information on NSP network infrastructure within a specified geographical location and the location of customer sites that will need to link to the existing NSP network infrastructure. The client 100 may access the network design database 106 over a network 108, such as a Local Area Network (LAN), Wide Area Network (WAN), the Internet, and Intranet, etc. Alternatively, the client 100 may be directly connected to the system implementing the network design database 106. The network design database 106 may implement any data store architecture known in the art, such as a relational database, non-relational database, etc.

The client 100 includes a client data manager 110, which is used to upload client information for a user to the network design database 106. The network design tool 102 may utilize a database client program to submit queries to a database server controlling access to the network design database 106 to access and update the data therein.

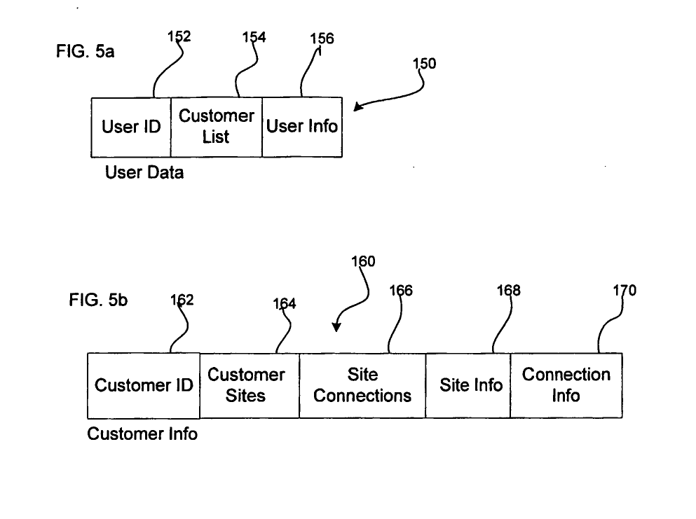

FIGS. 4a, 4b, and 4c illustrate examples of data structures including information on NSP network infrastructure maintained in the network design database 106. FIG. 4a illustrates NSP information 120 maintained for each NSP for which network infrastructure information is available. The NSP information 120 for one NSP includes an NSP identifier 122, a switch list 124 identifying the one or more switches deployed by that NSP and a path list 126 providing information on the geographical location of one or more network routes made available by the NSP that are accessible through the switches identified in the switch list 124.

FIG. 4b illustrates switch information 130 providing information on each switch identified in the switch lists 124 in the NSP information records 120. The switch information 130 for a switch includes a switch identifier 132, such as a unique world wide name or serial number, a switch geographical location 134, e.g., latitude and longitude, and switch bandwidth 136 indicating the network bandwidth available through that switch.

FIG. 4c illustrates path information 140 providing information on each path or network route identified in the path list 126 of the NSPs. A network path may comprise cables, wires, optical fiber, copper wire or a wireless network, e.g., “hot zone”, covering a defined geographic region. The path information 140 for a switch includes: a path (route) identifier 142; a list 144 of the switches along the route of the path, a geographical route 146 comprising spatial and geographical information identifying the physical route of the network path or area, which may include the multiple points or a radius defining the geographical route or area of the path; and the path bandwidth 148 indicating the network bandwidth available through that path.

The available infrastructure offered by an NSP would be defined by the switches and paths provided by that NSP as indicated in the switch 130 and path 140 information in the network design database 106. Additional information on the NSP network infrastructure may also be provided.

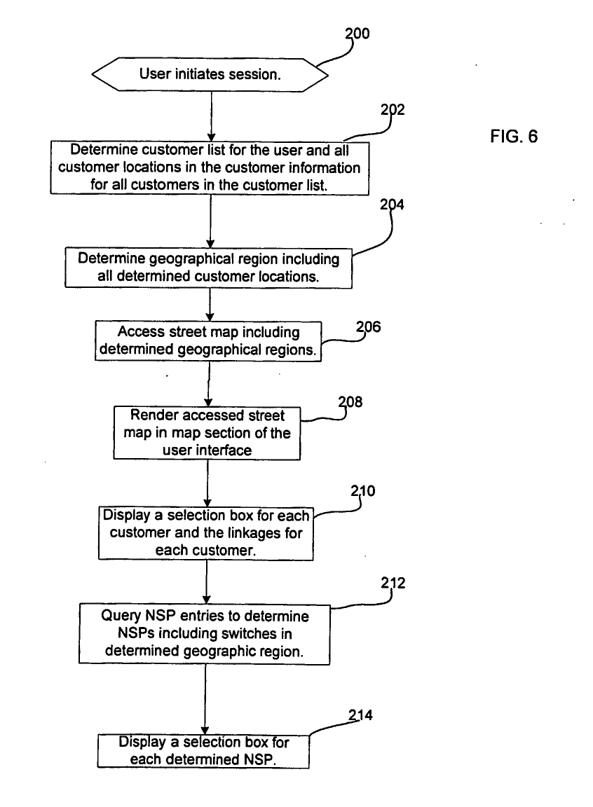

The network design database 106 would further include information on users authorized to access the network design database and groups of customer locations maintained for that user. FIG. 5a illustrates a user data record 150 including: a user identifier (ID) 152, which may also include a password to authorize access; a customer list 154 including multiple customers for that user, where each customer is a grouping associated with one or more customer sites potentially needing network access; and other user information 156, such as settings or preferences of a user.

FIG. 5b illustrates the customer information 160, where there is customer information 160 for every customer identified in the customer list 154 for the users. The customer information 160 includes: a customer identifier 162, which may include descriptive information; customer sites 164 indicating one or more customer sites requiring network access, including longitude and latitude information of each site; site connections 166 indicating connections between the customer sites; site information 168 including information on the site, such as network bandwidth, street address, users at site, etc.; and location connection information 170 providing information on the connections between the sites, such as bandwidth, etc.

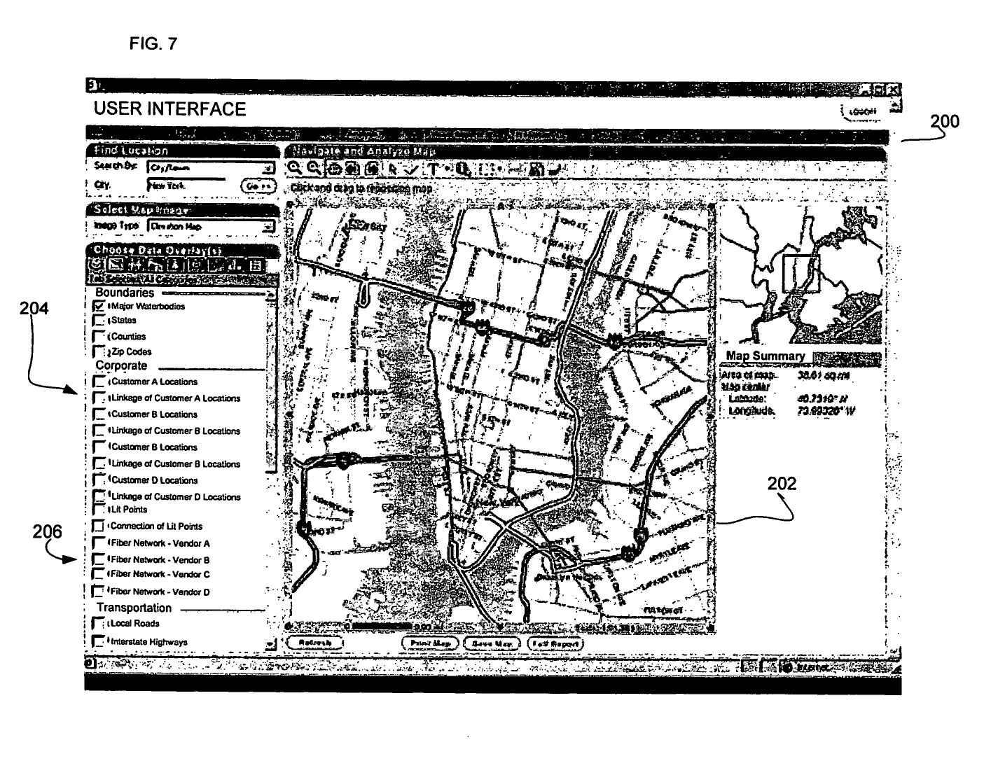

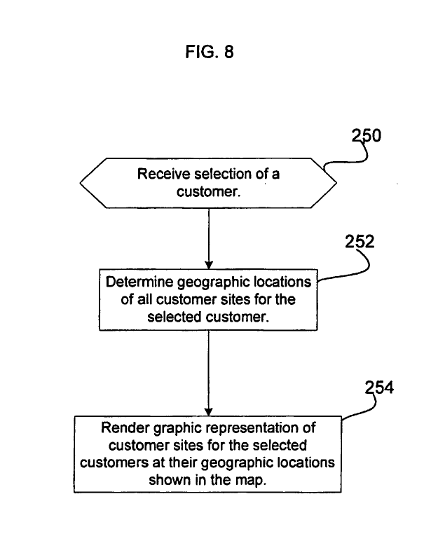

FIG. 6 illustrates operations performed by the network design tool 102 program to initiate a user session to access information in the network design database 106. Upon the user initiating a session (at block 200), the network design tool 102 determines (at block 202) the customer list 154 from the user data 150 for the user initiating the session and determines from the customer information 160 for each customer identified in the determined customer list 154 all customer site locations. A geographical region encompassing all determined customer site locations is determined (at block 204). A street map including the determined geographical region is then accessed (at block 206). The network design database 106 may include a street map database or the street map may be accessed from another street mapping program. The accessed street map region is rendered (at block 208) in a map section of the user interface 104, such as the map section 202 shown in the GUI 206 of FIG. 7. The map section 202 may display all or a portion of the accessed street map region accessible through scrolling user interface elements.

A selection box is then displayed (at block 210) for each customer in the user customer list 154 in the user interface 104, such as the displayed section 204 of the user interface 300 listing each customer in the customer list for the user and a check box next to each customer name to enable selection of that customer, where each customer is capable of being associated with one or more customer sites. The network design tool 102 may query (at block 212) the NSP information 120 (FIG. 4a) for each NSP included in the network design database 106 to determine those NSPs having switches in the determined geographic region, based on the switch location information 134 in the switch information 130. The name of each NSP having a switch in the determined geographic region is then rendered along with a check box enabling selection of the NSP. The user interface 200 of FIG. 7 shows a display region 206 listing NSPs providing fiber or network resources, including switches and paths, within the determined geographic region.

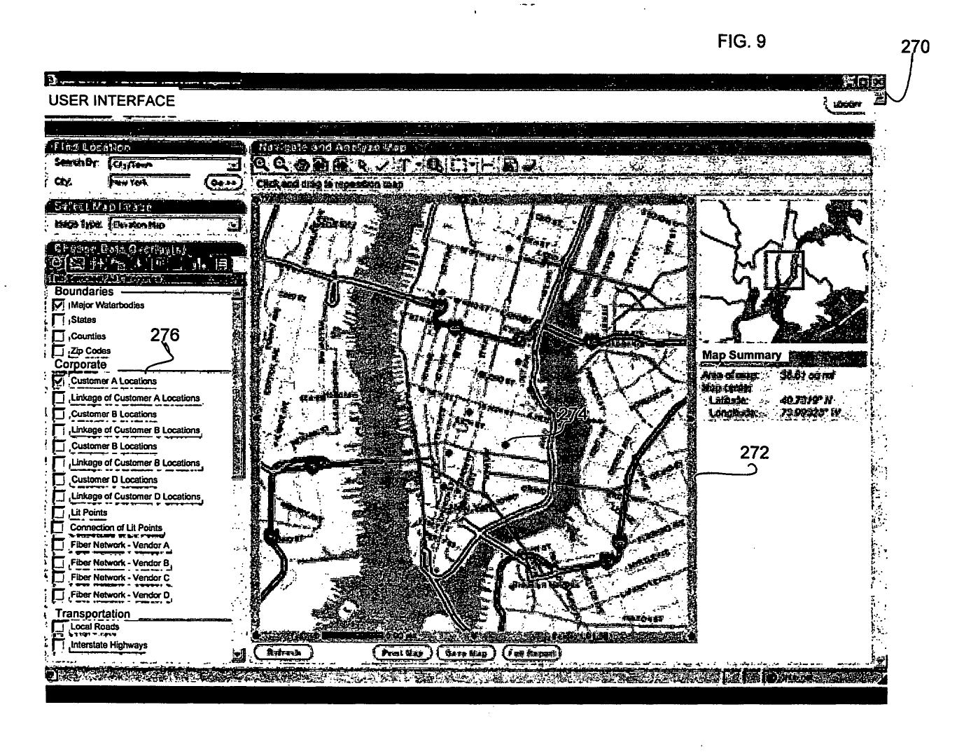

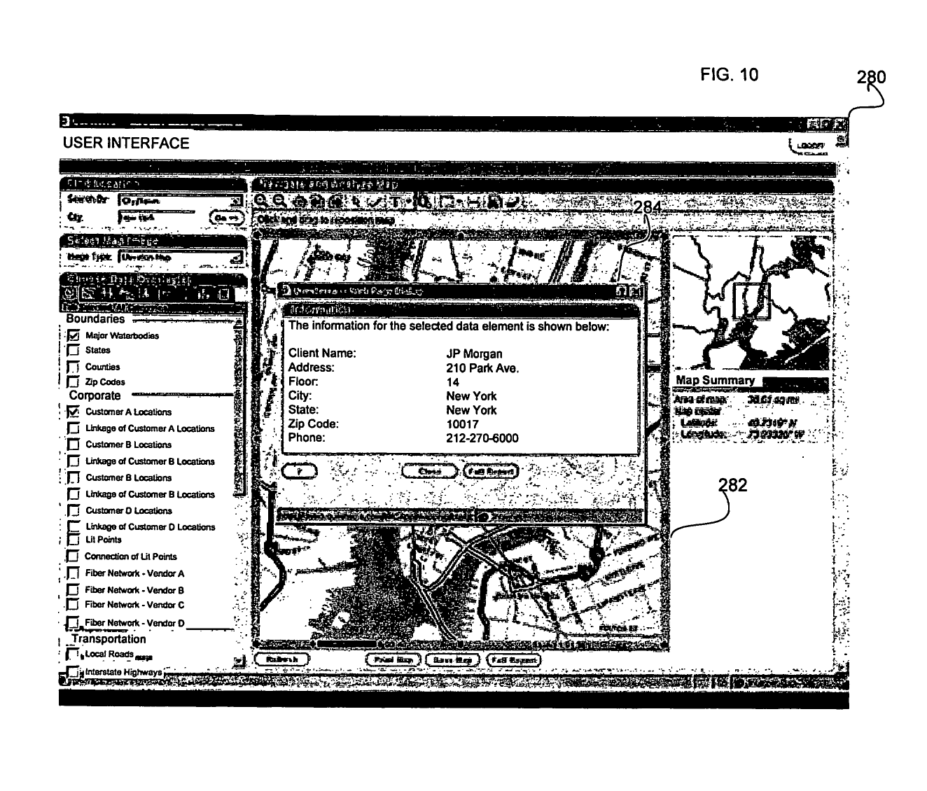

FIG. 8 illustrates operations performed by the network design tool 102 to render information in the user interface 104 on the customer sites. Upon receiving (at block 250) user selection of a customer, which may be made by selecting one of the customer check boxes shown in the region 204 of the user interface 200 (FIG. 7), a determination is made (at block 252) of all customer site locations for the selected customer from the customer site 164 information in the customer information 160 (FIG. 5b). A graphic representation of all the determined customer sites is rendered (at block 206) at the customer geographic locations shown in the map region. FIG. 9 illustrates a user interface 270 whose map region 272 displays the customer sites in the street map as small darkened circles, e.g., 274, thereby allowing identification of the customer sites for a selected customer, which in user interface 270 is “Customer A” 276.

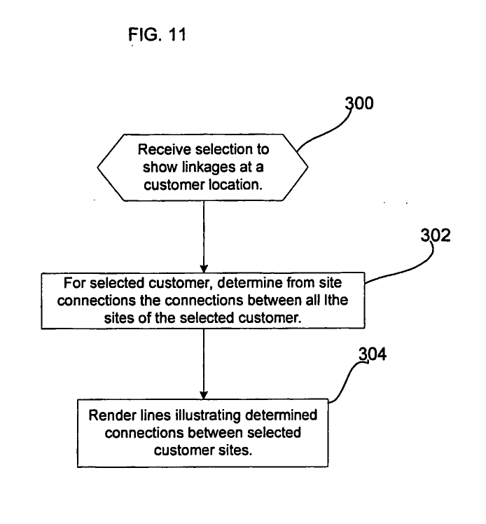

FIG. 10 illustrates a user interface 280 showing information that is displayed when a user selects a site location in the map region 282 and then selects to display information on that site in dialog box 284, such as by selecting an icon or menu item from the user interface 280. The rendered site information 284 may be accessed from the site information 168 for that customer site in the customer information 160 (FIG. 5b) in the database 106.

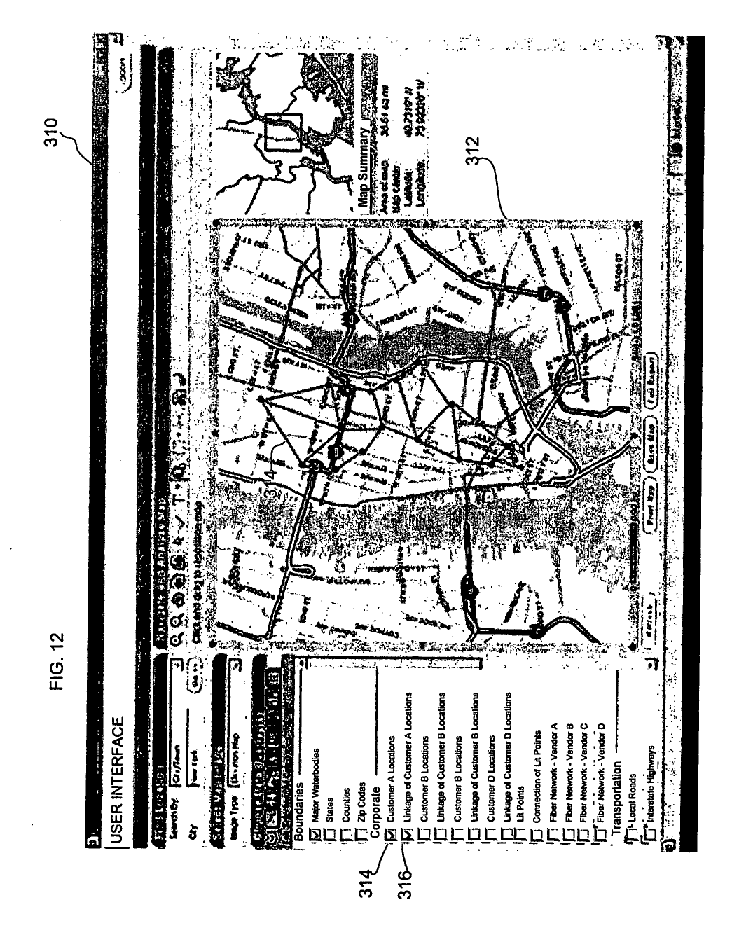

FIG. 11 illustrates operations performed by the network design tool 102 to render linkages between the customer sites in the user interface 104. Upon receiving (at block 300) user selection of a “show linkages” box for a listed customer, a determination is made (at block 302) of the connections between all the customer sites of the selected customer and lines are rendered (at block 304) illustrating the determined connections between the selected customer sites.

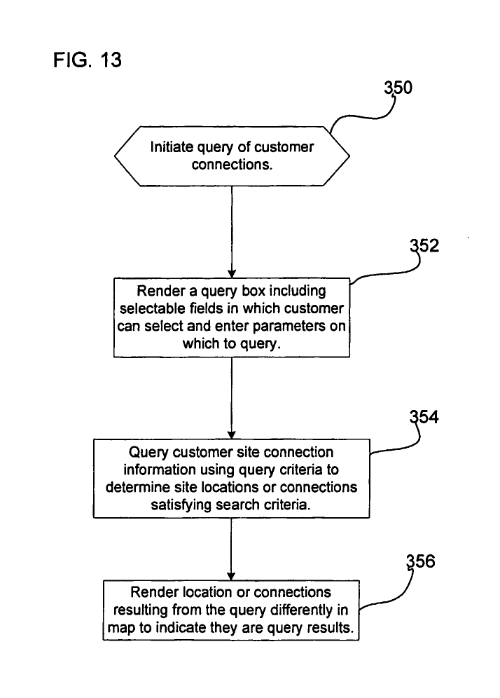

FIG. 12 illustrates a user interface 310 showing in the map region 312 the determined connections, e.g., 314, between the customer sites for Customer A, where the selection box to cause the display of the sites for customer A and the linkages of customer A are shown as elements 314 and 316, respectively.

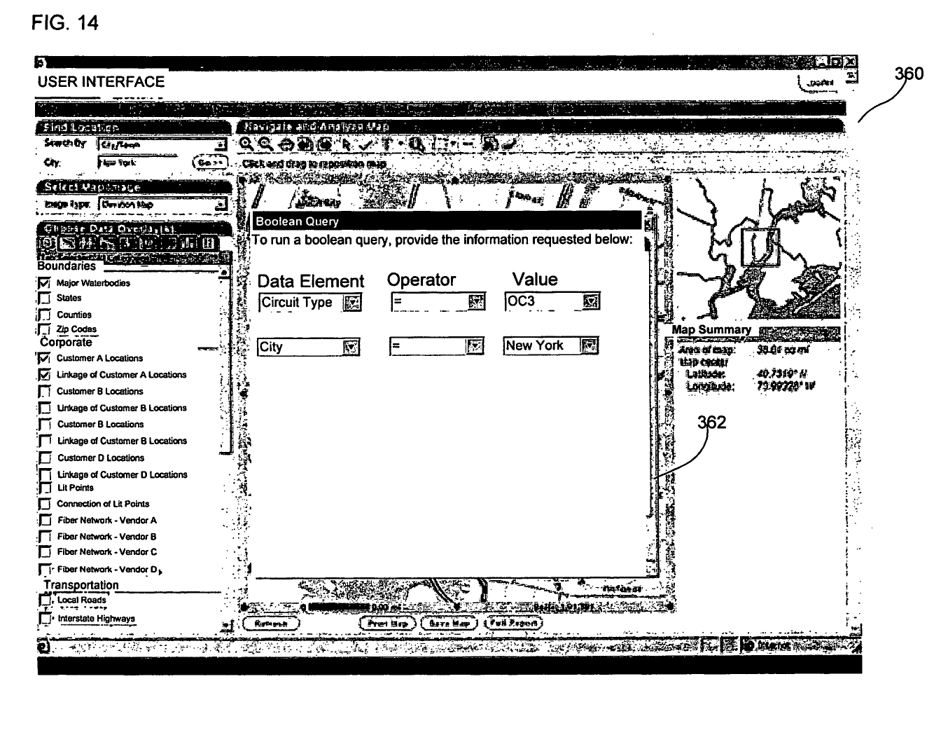

FIG. 13 illustrates operations performed by the network design tool 102 to perform a query related to the customer connections to determine information thereon. Upon initiating (at block 350) a query of customer connections, a query box is rendered (at block 352) including selectable fields in which a user can select and enter search criteria on parameters to query. The network design tool 102 would then initiate a query (at block 354) of the site 164 or connection 166 information to determine site locations or connections satisfying the search criteria. The location or connections resulting from the query are rendered (at block 356) differently in the map region to indicate they are query results.

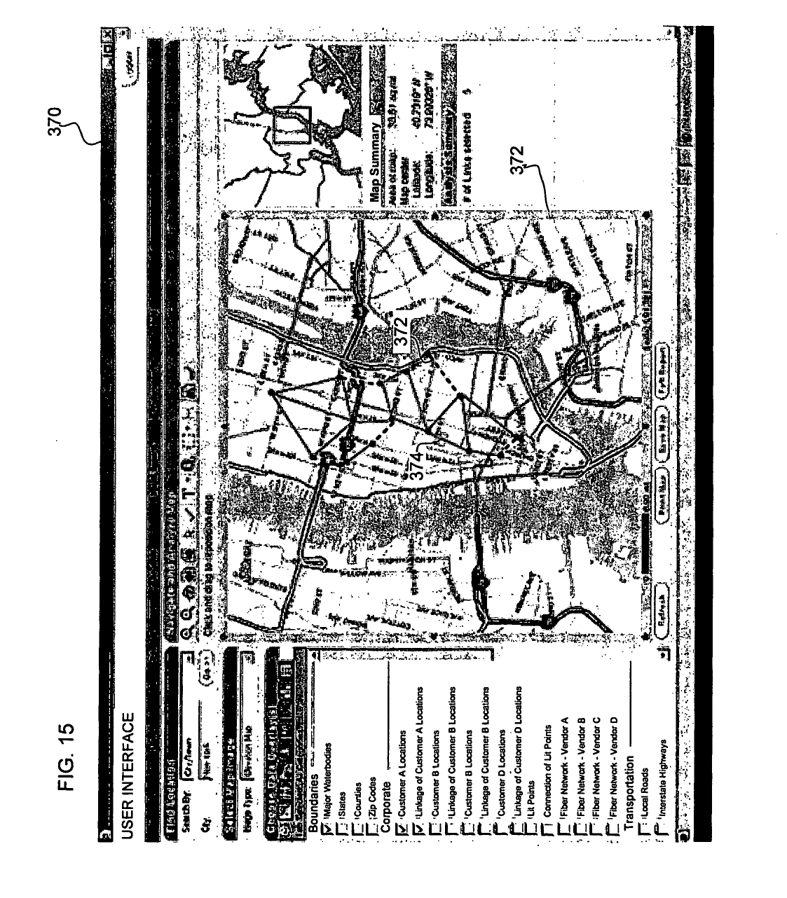

FIG. 14 illustrates a user interface 360 showing the display of a query box 362 in which the user may select parameters and search criteria on which to query. For instance, the user may select to query on switch type and/or a specific geographical location, such as city, zip code, street, etc., and enter or select the search criteria of the query parameters in the query box 362.

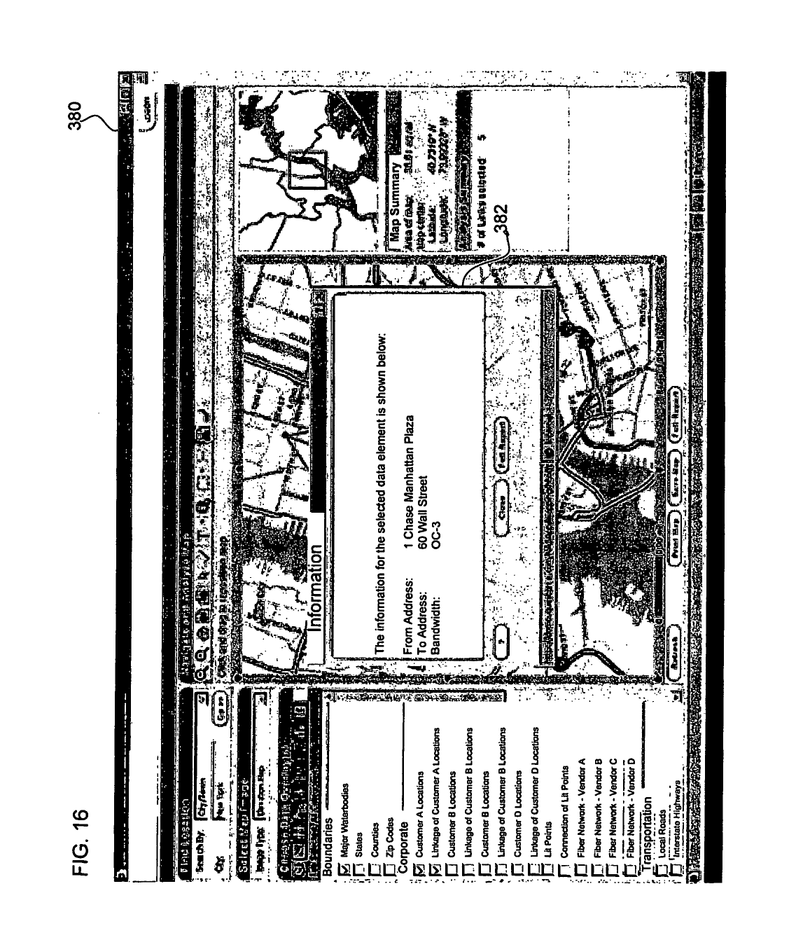

FIG. 15 illustrates a user interface 370 showing the rendering of the connections resulting from the query in a different manner than other connections. For instance, in the map region 372, the connections satisfying the query parameters, such as connections which would use a certain switch type, e.g., Optical Carrier 3 (OC3), have a certain bandwidth, etc., are rendered with a dashed line, e.g., 374, whereas connections that do not satisfy the query are rendered differently, such as with a solid line, e.g., 376.

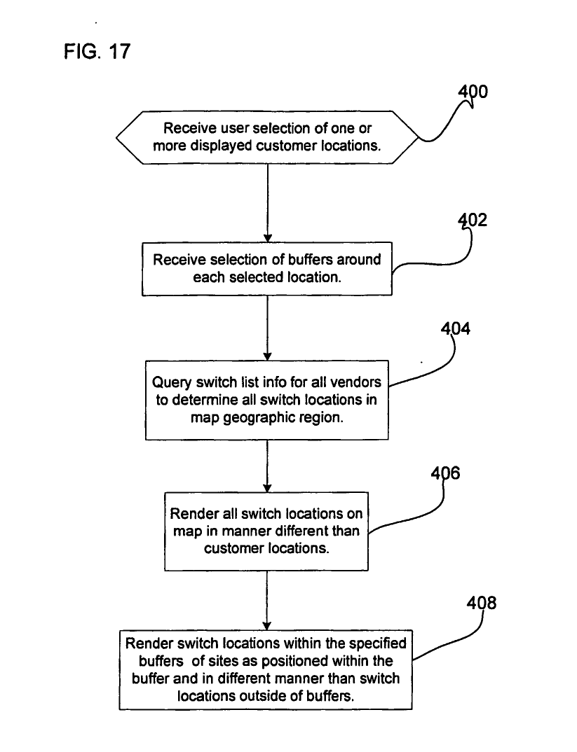

FIG. 16 illustrates a user interface panel 380 displaying a dialog box 382 including information on a connection, which would be rendered in response to the user selecting a displayed connection and then selecting to display information on the selected connection, where the information rendered in the dialog box 382 would be accessed from the connection information 170 (FIG. 5b).

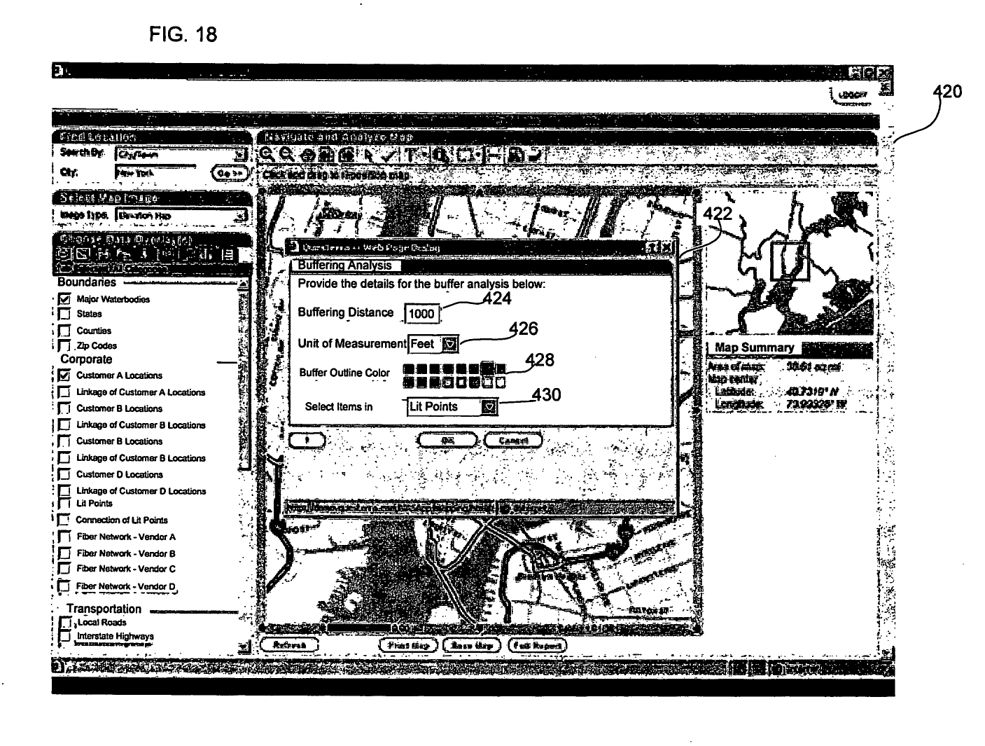

FIG. 17 illustrates operations the network design tool 102 performs to allow the user to obtain information on NSP network infrastructure available at customer sites. The user would select (at block 400) one or more displayed customer sites and enter information (at block 402) defining a buffer region for the selected site, where the buffer specifies a region, such as a radius, around a site location to consider for available NSP infrastructure. The network design tool 102 then queries (at block 404) the switch information 130 to find all switches whose geographic location 134 (FIG. 4b) falls within the boundaries of the buffer defined around one of the selected customer sites. All determined switch locations are rendered (at block 406) in the map region in manner different than the customer sites are rendered to distinguish the two. All the determined switch locations in a buffer are rendered (at block 408) in the map region as contained within the buffer region in a manner different than the switch locations that do not fall within one buffer region.

The buffers would identify those NSP switches that the network designer may select to use as the network infrastructure for the selected customer sites, i.e., that network infrastructure with a defined geographic proximity (within the buffer) to NSP network infrastructure.

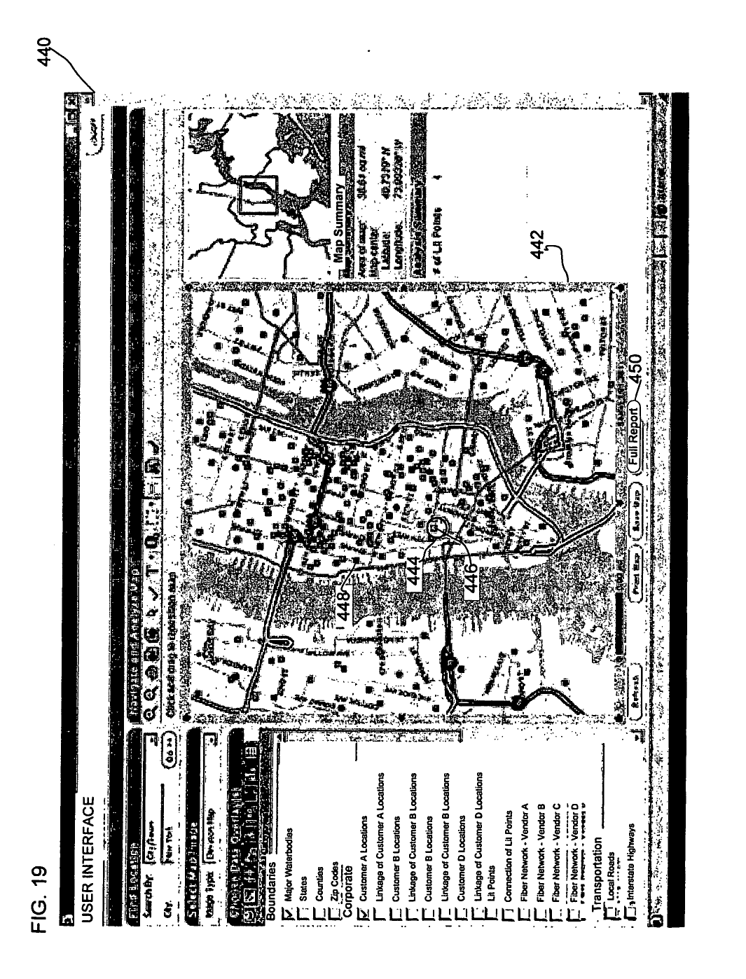

FIG. 18 illustrates a user interface 420 having a dialog box 422 in which the user enters a buffering distance 424, a unit measurement 426 of the buffer distance, a color 428 in which to render the buffer region, and a manner in which to render the representations of the switches that fall within the buffer region 428, e.g., lighted points, etc.

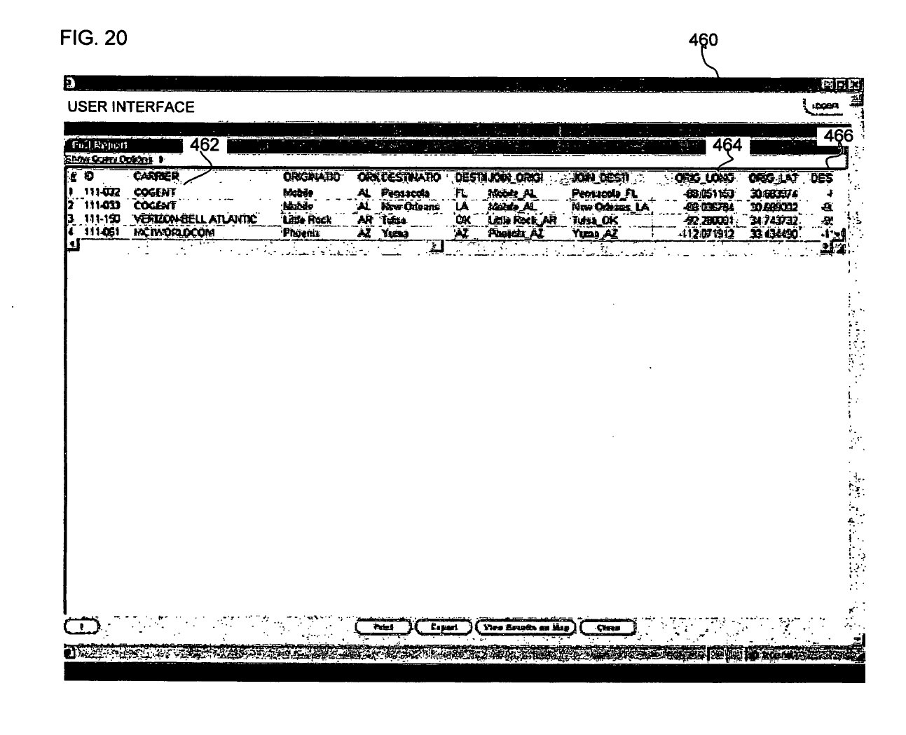

FIG. 19 illustrates a user interface 440 including a map region 442 in which is displayed a buffer region, represented by circle 444, including switch sites displayed lit 446, as opposed to switch sites displayed outside of the buffer region 444 shown as darkened boxes, e.g., 448. The user may select a “full report” button 450 to generate a report on all the switches that fall within the buffers around the selected customer sites.

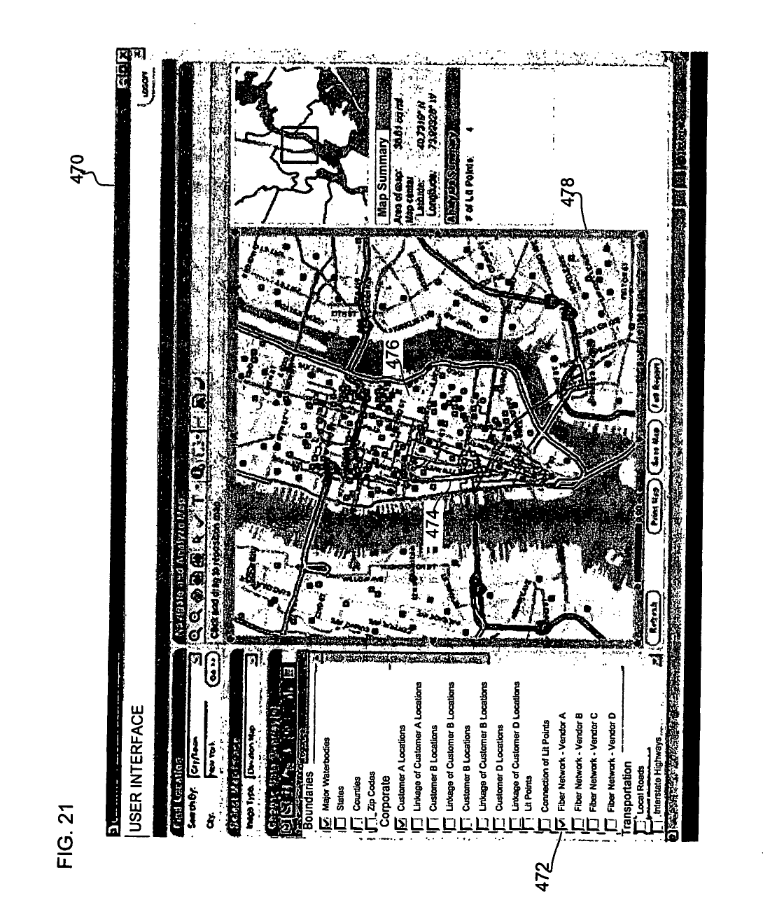

FIG. 20 illustrates an example of the full report rendered in user interface 460 including information on all the switches that are located within the selected buffer regions of the selected customer sites. The report would include information identifying the switch, such as the NSP 462, the geographical location 464 in terms of longitude and latitude, and the distance from the customer site 466. The network designer may review this full report to determine a switch and NSP to use to connect to from the customer site.

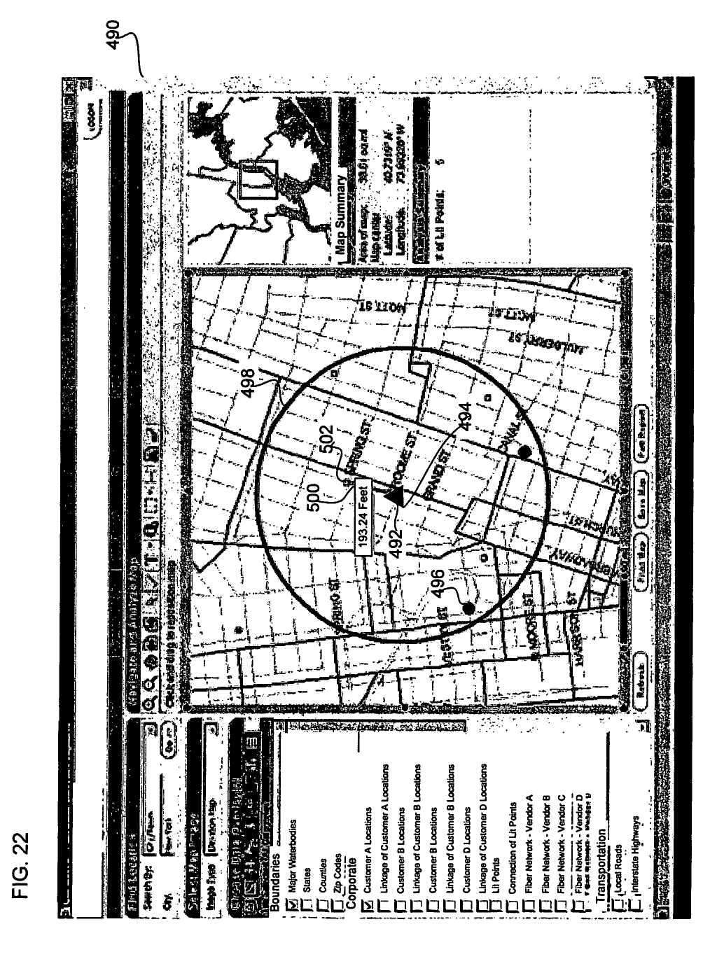

FIG. 21 illustrates a user interface 470 rendering the network connections between the switch sites for a selected vendor, which in user interface 470 is the vendor 472. The network connections between NSP switches would be rendered as overlaid over the rendering of the transportation corridors or other rendered points-of-interest in the map. Number 472 identifies a rendered connection and number 474 identifies a rendered street in the map region 476. The rendered connections may be displayed darker and overlaid over the rendered transportation corridors. This allows the network designer to visualize the route of the connections for the selected NSP overlaid with respect to the street layout of the map.

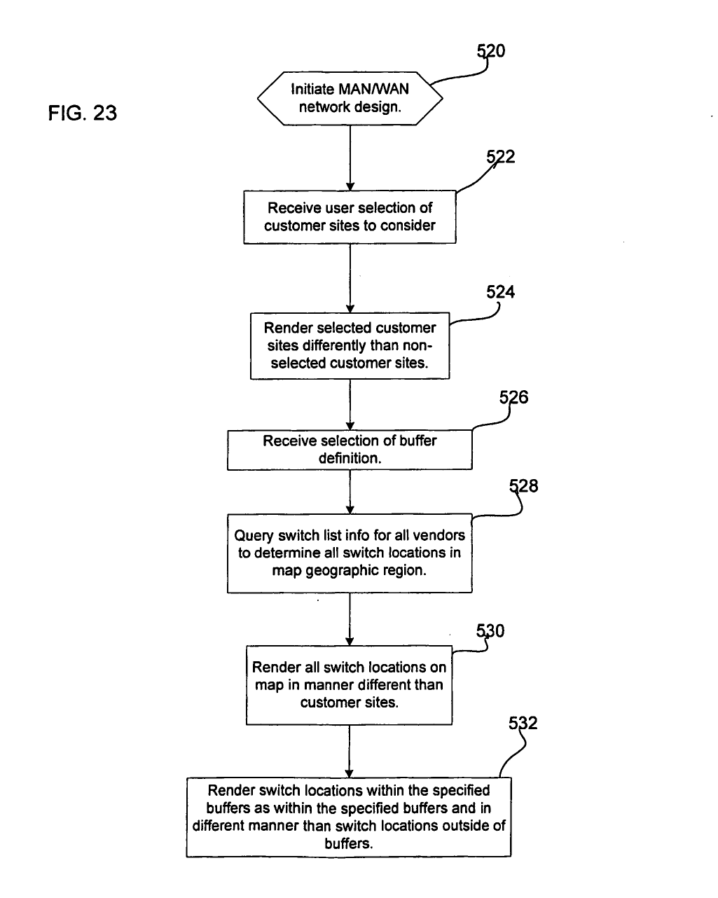

FIG. 22 illustrates a user interface 490 showing a zoom view of a customer site, shown as triangle 492, which provides greater detail as to the street location, and shows other switches, e.g., 494 and other customer sites, e.g., 496, within the displayed buffer region 498. User interface 490 further shows a line 500 the network designer would have added from one switch 502 in the buffer 498 and the zoomed customer site 492, which would further visualize information on such a proposed connection, such as the distance.

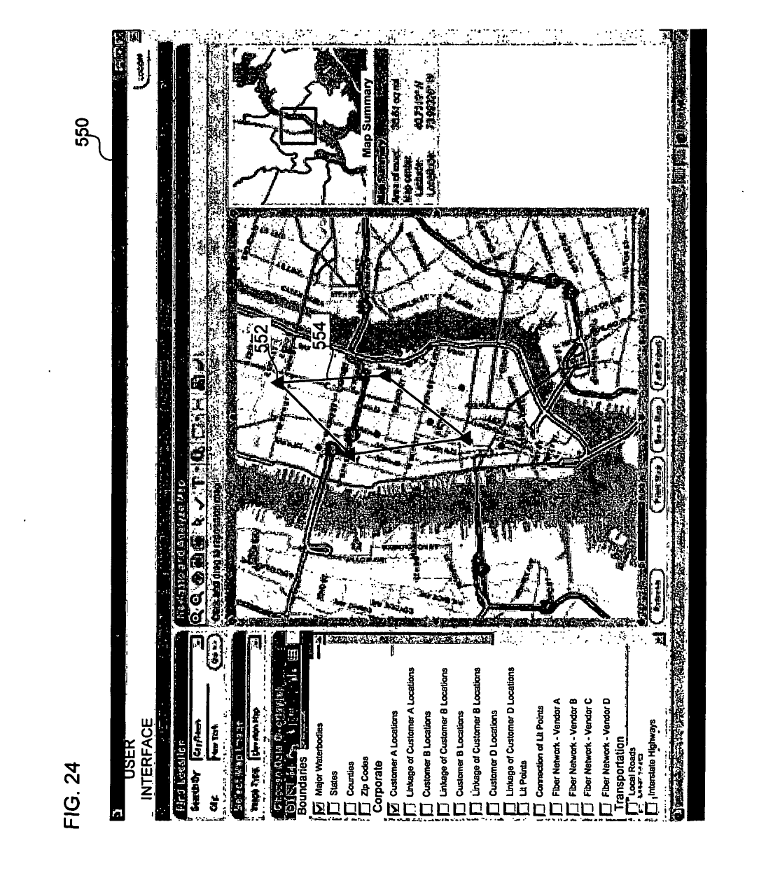

FIG. 23 shows operations the network design tool 102 may perform to assist the user in visualizing different network design options. Upon initiating (at block 520) the design operations to design a network, such as a Metropolitan Area Network, (MAN)/Wide Area Network (WAN), the network design tool 102 receives (at block 522) user selection of customer sites to consider as nodes in the network being designed. The user selected customer sites are rendered (at block 524) differently than non-selected customer sites. The buffer region definition is further received (at block 526), which may be entered through a dialog box such as shown as box 422 in FIG. 18. The switch information 132 for all switches are queried (at block 528) to locate all switch locations in the buffer regions for the selected sites. All determined switch locations are rendered (at block 530) on the map in a manner different than the rendering of the customer sites. The switch locations are further rendered (at block 532) within the rendered buffer regions in a different manner than the switch locations outside of the buffer regions.

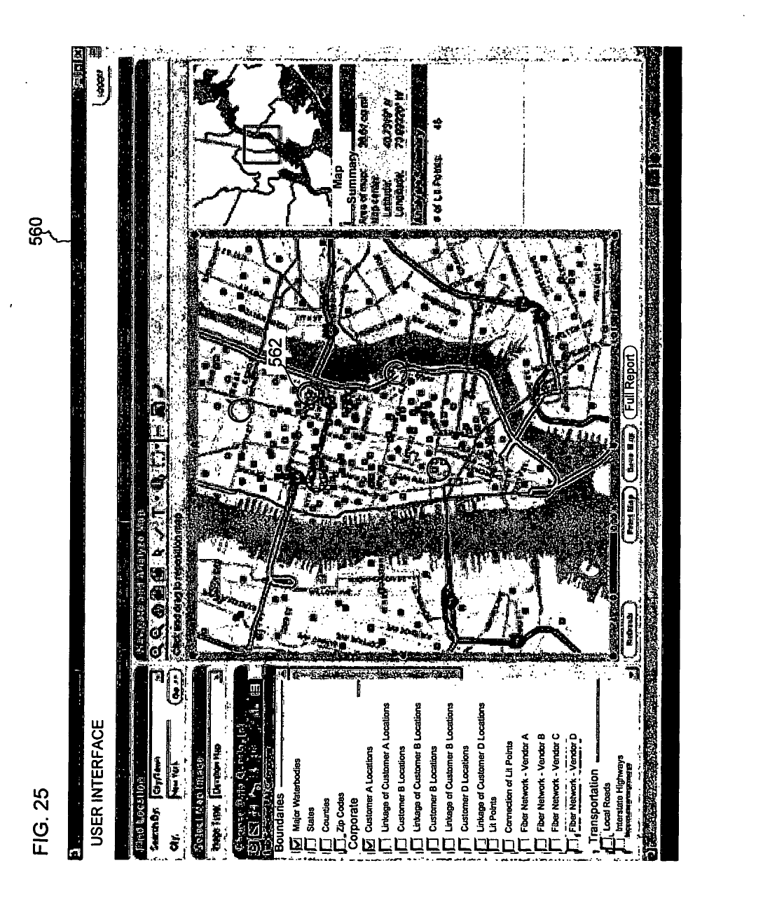

FIG. 24 illustrates a user interface 550 including four selected customer sites, e.g., 552, and lines, e.g., 554, drawn between the sites illustrating a network ring that may be formed for the selected customer sites.

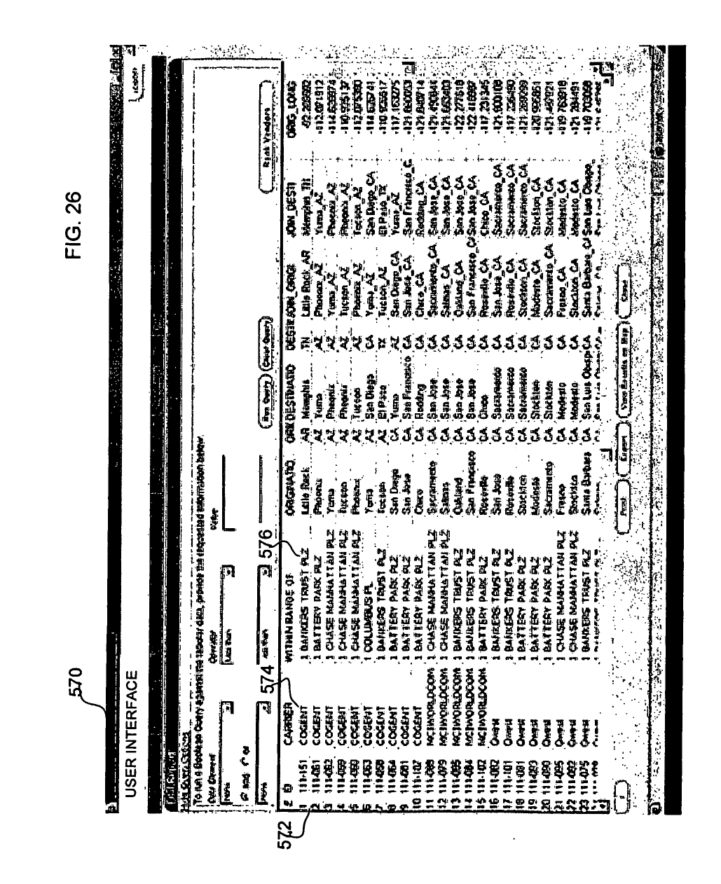

FIG. 25 illustrates a user interface 560 including buffers, e.g., 562, rendered around each of the selected customer sites.

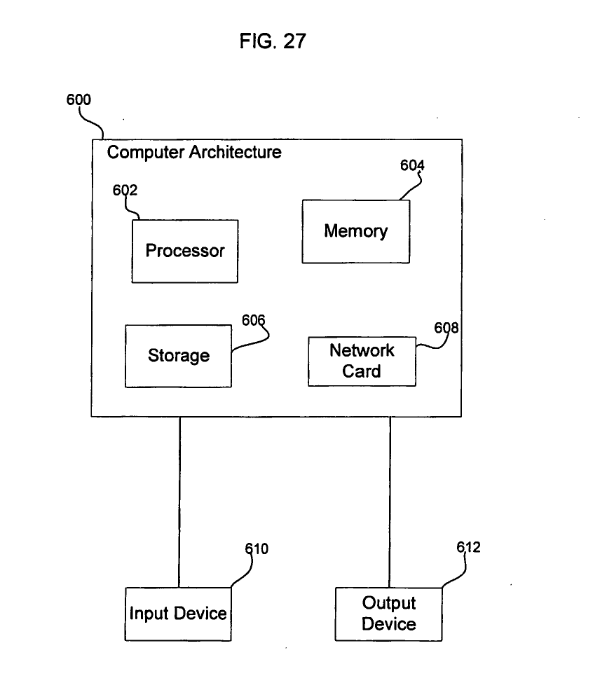

FIG. 26 illustrates a user interface 570 showing a report of all the switches and their NSPs that fall within the buffer region of each of the selected customer sites, including the switch ID 572, the switch NSP 574, and the customer site address 576, as well as other information that would assist the network designer in designing a network.

The described network design tool enables a network designer to visualize customer sites, NSP network infrastructure and the relationship therebetween to provide information the network designer may then use to select optimal network infrastructure from the determined best possible NSPs. The rendered information allows network designers to make a comprehensive assessment and analysis of network infrastructure available for use with their network nodes.

### Additional Embodiment Details

The described network design tool may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

FIGS. 4a, 4b, 4c and 5a, 5b illustrate examples of data structures that maintain information on customer sites and NSP network infrastructure. This information may be maintained in a format different than shown. Further, additional information may be provided for the customer sites and NSP resources.

Certain figures, such as FIGS. 7, 9, 10, 12, 14-16, 18-22, 24, 25, and 26, depict a GUI interface with the map region and selectable customers and vendors in a particular orientation. In alternative embodiments, the arrangement of the GUI may differ and include different, less or more information than shown.

The described embodiments discussed allowing a network designer to query and render information on customer sites, NSP switches, and NSP paths. Additional information on the NSP resources and customer sites may additionally be provided and stored in the network design database.

The illustrated logic of FIGS. 1, 6, 8, 11, 13, 17, and 23 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

FIG. 27 illustrates one implementation of a computer architecture 600 of the network components shown in FIGS. 1 and 3, such as in the clients, server, database, etc. The architecture 600 may include a processor 602 (e.g., a microprocessor), a memory 604 (e.g., a volatile memory device), and storage 606 (e.g., a non-volatile storage, such as magnetic disk drives, optical disk drives, a tape drive, etc.). The storage 606 may comprise an internal storage device or an attached or network accessible storage. Programs in the storage 606 are loaded into the memory 604 and executed by the processor 602 in a manner known in the art. The architecture further includes a network card 608 to enable communication with a network. An input device 610 is used to provide user input to the processor 602, and may include a keyboard, mouse, pen-stylus, microphone, touch sensitive display screen, or any other activation or input mechanism known in the art. An output device 612 is capable of rendering information transmitted from the processor 602, or other component, such as a display monitor, printer, storage, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method, comprising:
receiving a selection of customer sites;
querying a database to determine geographical locations of the selected customer sites;
rendering, in a graphical user interface, representations of the selected customer sites in a map at the geographical location of the selected sites in the map;
receiving selection of at least one network service provider (NSP);
querying the database to determine network infrastructure of the selected NSP and geographical locations of the determined network infrastructure; and
rendering representations of the determined network infrastructure in a map at the determined geographical locations of the determined network infrastructure to render a visualization of the geographical locations of the selected customer sites and network infrastructure of the selected at least one NSP in the map.

2. The method of claim 1, wherein the determined network infrastructure comprises at least one of a switch and a network path, and wherein the network infrastructure geographical location comprises at least one of a switch site location and a route of the network path.

3. The method of claim 1, wherein the map comprises a street map, and wherein the rendered map visualizes transportation corridors, and wherein the rendered customer sites and network infrastructure are visualized superimposed over rendered transportation corridors in the street map.

4. The method of claim 1, further comprising:
receiving user selection of one rendered customer site;
querying the database to determine information on the selected customer site; and
rendering the determined information on the selected customer site in a dialog box.

5. The method of 1, further comprising:
querying connection information in the database to determine connections between the rendered customer sites; and
rendering connections between the customer sites in the map to visualize the determined connections.

6. The method of claim 5, further comprising:
receiving a query including search criteria with respect to a parameter concerning network connectivity at the customer sites;
querying the database to determine connections between customer sites having network connectivity information satisfying the search criteria included with the query; and
rendering the determined connections in a different visual manner than those connections that do not satisfy the search criteria.

7. The method of claim 5, wherein the connection information includes information on at least one of connected sites, connection bandwidth, and connection circuit types.

8. The method of claim 1, further comprising:
receiving a definition of a buffer region with respect to a selected customer site;
querying the database to determine NSP network infrastructure located within the defined buffer region;
rendering the buffer region around the rendering of the selected customer site in the map; and
rendering the determined NSP network infrastructure within the defined buffer region in the map.

9. The method of claim 8, wherein NSP network infrastructure rendered within the defined buffer region is rendered differently than NSP network infrastructure rendered outside of the buffer region.

10. The method of claim 8, further comprising:
generating a report identifying at least one of: the network infrastructure located within the buffer region, the NSP managing the identified network infrastructure, and a distance of the identified network infrastructure from the selected customer site for which the buffer region is defined.

11. The method of claim 1, wherein the network infrastructure includes network switches and network paths, wherein rendering the representations of the determined network infrastructure comprises rendering representations of the determined switches in the map, further comprising:
querying the database to determine network paths between the network switches rendered in the map; and
rendering the network paths between the network switches in the map.

12. The method of claim 11, wherein the map comprises a street map, and wherein the network paths are rendered superimposed over transportation corridors rendered on the map.

13. The method of claim 11, further comprising:
receiving user selection of a proposed path between the customer site and one network switch;
rendering the proposed path in the map; and
generating and rendering information on the proposed path in the map, including information on the distance of the proposed path.

14. The method of claim 1, further comprising:
receiving selection of a plurality of customer sites rendered in the map;
receiving a definition of parameters of a buffer region with respect to the selected customer sites;
determining buffer regions for each of the selected customer sites satisfying the defined parameters for the buffer region;
querying the database to determine NSP network infrastructure located within each determined buffer region;
rendering each determined buffer region around each selected customer site in the map; and
rendering the determined NSP network infrastructure within each defined buffer region in the map.

15. The method of claim 14, further comprising:
generating a report identifying at least one of: the network infrastructure located within the determined buffer regions; the NSPs managing the identified network infrastructure within the determined buffer regions; and, for each selected customer site, a distance of the identified network infrastructure from the selected customer site within the buffer region for the selected customer site.

16. A system, comprising:
a processor;
an output device in communication with the processor;
code executed by the processor to cause the processor to perform:
(i) receiving a selection of customer sites;
(ii) querying a database to determine geographical locations of the selected customer sites;
(iii) rendering, in a graphical user interface, representations of the selected customer sites in a map at the geographical location of the selected sites in the map;
(iv) receiving selection of at least one network service provider (NSP);
(v) querying the database to determine network infrastructure of the selected NSP and geographical locations of the determined network infrastructure; and
(vi) rendering representations of the determined network infrastructure in a map at the determined geographical locations of the determined network infrastructure to render a visualization of the geographical locations of the selected customer sites and network infrastructure of the selected at least one NSP in the map.

17. The system of claim 16, wherein the determined network infrastructure comprises at least one of a switch and a network path, and wherein the network infrastructure geographical location comprises at least one of a switch site location and a route of the network path.

18. The system of claim 16, wherein the map comprises a street map, and wherein the rendered map visualizes transportation corridors, and wherein the rendered customer sites and network infrastructure are visualized superimposed over rendered transportation corridors in the street map.

19. The system of claim 16, wherein the code further causes the processor to perform:
receiving user selection of one rendered customer site;
querying the database to determine information on the selected customer site; and
rendering the determined information on the selected customer site in a dialog box.

20. The system of claim 16, wherein the code further causes the processor to perform:
querying connection information in the database to determine connections between the rendered customer sites; and
rendering connections between the customer sites in the map to visualize the determined connections.

21. The system of claim 20, wherein the code further causes the processor to perform:
receiving a query including search criteria with respect to a parameter concerning network connectivity at the customer sites;
querying the database to determine connections between customer sites having network connectivity information satisfying the search criteria included with the query; and
rendering the determined connections in a different visual manner than those connections that do not satisfy the search criteria.

22. The system of claim 16, wherein the connection information includes information on at least one of connected sites, connection bandwidth, and connection circuit types.

23. The system of claim 16, wherein the code further causes the processor to perform:
receiving a definition of a buffer region with respect to a selected customer site;
querying the database to determine NSP network infrastructure located within the defined buffer region;
rendering the buffer region around the rendering of the selected customer site in the map; and
rendering the determined NSP network infrastructure within the defined buffer region in the map.

24. The system of claim 23, wherein NSP network infrastructure rendered within the defined buffer region is rendered differently than NSP network infrastructure rendered outside of the buffer region.

25. The system of claim 24, wherein the code further causes the processor to perform:
generating a report identifying at least one of: the network infrastructure located within the buffer region, the NSP managing the identified network infrastructure, and a distance of the identified network infrastructure from the selected customer site for which the buffer region is defined.

26. The system of claim 16, wherein the network infrastructure includes network switches and network paths, wherein rendering the representations of the determined network infrastructure comprises rendering representations of the determined switches in the map, and wherein the code further causes the processor to perform:
querying the database to determine network paths between the network switches rendered in the map; and
rendering the network paths between the network switches in the map.

27. The system of claim 26, wherein the map comprises a street map, and wherein the network paths are rendered superimposed over transportation corridors rendered on the map.

28. The system of claim 26, wherein the code further causes the processor to perform:
receiving user selection of a proposed path between the customer site and one network switch;
rendering the proposed path in the map; and
generating and rendering information on the proposed path in the map, including information on the distance of the proposed path.

29. The system of claim 16, wherein the code further causes the processor to perform:
receiving selection of a plurality of customer sites rendered in the map;
receiving a definition of parameters of a buffer region with respect to the selected customer sites;
determining buffer regions for each of the selected customer sites satisfying the defined parameters for the buffer region;
querying the database to determine NSP network infrastructure located within each determined buffer region;
rendering each determined buffer region around each selected customer site in the map; and
rendering the determined NSP network infrastructure within each defined buffer region in the map.

30. The system of claim 16, wherein the code further causes the processor to perform:
generating a report identifying at least one of: the network infrastructure located within the determined buffer regions; the NSPs managing the identified network infrastructure within the determined buffer regions; and, for each selected customer site, a distance of the identified network infrastructure from the selected customer site within the buffer region for the selected customer site.

31. An article of manufacture for causing operations to be performed, wherein the operations comprise:
receiving a selection of customer sites;
querying a database to determine geographical locations of the selected customer sites;
rendering, in a graphical user interface, representations of the selected customer sites in a map at the geographical location of the selected sites in the map;
receiving selection of at least one network service provider (NSP);
querying the database to determine network infrastructure of the selected NSP and geographical locations of the determined network infrastructure; and
rendering representations of the determined network infrastructure in a map at the determined geographical locations of the determined network infrastructure to render a visualization of the geographical locations of the selected customer sites and network infrastructure of the selected at least one NSP in the map.

32. The article of manufacture of claim 31, wherein the determined network infrastructure comprises at least one of a switch and a network path, and wherein the network infrastructure geographical location comprises at least one of a switch site location and a route of the network path.

33. The article of manufacture of claim 31, wherein the map comprises a street map, and wherein the rendered map visualizes transportation corridors, and wherein the rendered customer sites and network infrastructure are visualized superimposed over rendered transportation corridors in the street map.

34. The article of manufacture of claim 31, wherein the operations further comprise:
receiving user selection of one rendered customer site;
querying the database to determine information on the selected customer site; and
rendering the determined information on the selected customer site in a dialog box.

35. The article of manufacture of claim 31, wherein the operations further comprise:
querying connection information in the database to determine connections between the rendered customer sites; and
rendering connections between the customer sites in the map to visualize the determined connections.

36. The article of manufacture of claim 35, wherein the operations further comprise:
receiving a query including search criteria with respect to a parameter concerning network connectivity at the customer sites;
querying the database to determine connections between customer sites having network connectivity information satisfying the search criteria included with the query; and
rendering the determined connections in a different visual manner than those connections that do not satisfy the search criteria.

37. The article of manufacture of claim 35, wherein the connection information includes information on at least one of connected sites, connection bandwidth, and connection circuit types.

38. The article of manufacture of claim 31, wherein the operations further comprise:
receiving a definition of a buffer region with respect to a selected customer site;
querying the database to determine NSP network infrastructure located within the defined buffer region;
rendering the buffer region around the rendering of the selected customer site in the map; and
rendering the determined NSP network infrastructure within the defined buffer region in the map.

39. The article of manufacture of claim 38, wherein NSP network infrastructure rendered within the defined buffer region is rendered differently than NSP network infrastructure rendered outside of the buffer region.

40. The article of manufacture of claim 38, wherein the operations further comprise:
generating a report identifying at least one of: the network infrastructure located within the buffer region, the NSP managing the identified network infrastructure, and a distance of the identified network infrastructure from the selected customer site for which the buffer region is defined.

41. The article of manufacture of claim 31, wherein the network infrastructure includes network switches and network paths, wherein rendering the representations of the determined network infrastructure comprises rendering representations of the determined switches in the map, further comprising:
querying the database to determine network paths between the network switches rendered in the map; and
rendering the network paths between the network switches in the map.

42. The article of manufacture of claim 41, wherein the map comprises a street map, and wherein the network paths are rendered superimposed over transportation corridors rendered on the map.

43. The article of manufacture of claim 41, wherein the operations further comprise:
receiving user selection of a proposed path between the customer site and one network switch;
rendering the proposed path in the map; and
generating and rendering information on the proposed path in the map, including information on the distance of the proposed path.

44. The article of manufacture of claim 31, wherein the operations further comprise:
receiving selection of a plurality of customer sites rendered in the map;
receiving a definition of parameters of a buffer region with respect to the selected customer sites;
determining buffer regions for each of the selected customer sites satisfying the defined parameters for the buffer region;
querying the database to determine NSP network infrastructure located within each determined buffer region;
rendering each determined buffer region around each selected customer site in the map; and
rendering the determined NSP network infrastructure within each defined buffer region in the map.

45. The article of manufacture of claim 44, wherein the operations further comprise:
generating a report identifying at least one of: the network infrastructure located within the determined buffer regions; the NSPs managing the identified network infrastructure within the determined buffer regions; and, for each selected customer site, a distance of the identified network infrastructure from the selected customer site within the buffer region for the selected customer site
